(19) United States
(12) Patent Application Publication
(10) Pub. No.: US 2017/0025204 A1
(43) Pub. Date: Jan. 26, 2017

(54) USB CABLE FOR SUPER SPEED DATA TRANSMISSION

(71) Applicant: THE CHEMOURS COMPANY FC, LLC, WILMINGTON, DE (US)

(72) Inventors: GREGORY ALLEN CHAPMAN, WASHINGTON, WV (US); SUNDAR KILNAGAR VENKATARAMAN, AVONDALE, PA (US); XIANJIANG XIAO, Shanghai (CN); ROBERT THOMAS YOUNG, NEW CASTLE, DE (US); LEIMING ZHANG, SHANGHAI (CN)

(21) Appl. No.: 15/203,864

(22) Filed: Jul. 7, 2016

Related U.S. Application Data
(60) Provisional application No. 62/195,593, filed on Jul. 22, 2015.

(51) Int. Cl. H01B 11/18; H01B 3/44; H01B 11/20

(52) U.S. Cl. CPC H01B 11/1895; H01B 11/20; H01B 3/445

(57) ABSTRACT

A USB cable for transmitting data at superspeed at a frequency of at least 10 GHz is provided, comprising a jacket, and positioned within said jacket at least a power cable and a plurality of shielded insulated conductors for transmitting said data at speeds up to 10 Gbps per channel, the insulation of said insulated conductors exhibiting a dissipation factor of no greater than 0.00035 at 10 GHz, and comprising melt-fabricable perfluoropolymer, such as tetrafluoroethylene/hexafluoropropylene copolymer or tetrafluoroethylene/perfluoro(alkyl vinyl ether) copolymer.

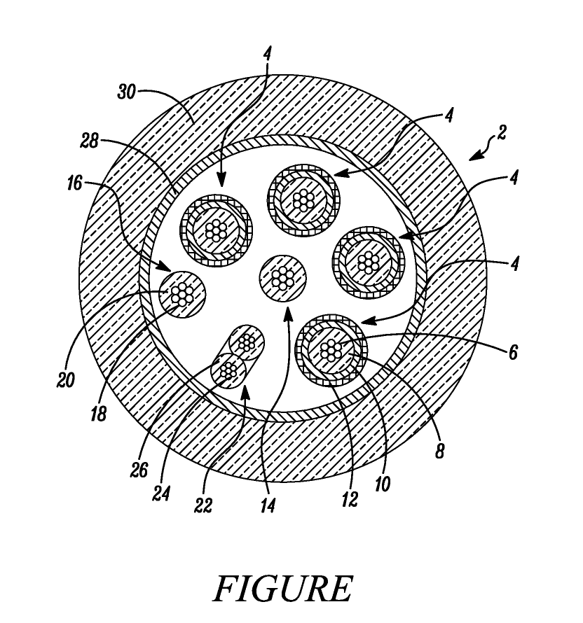

### CROSS-REFERENCE TO RELATED APPLICATIONS

This application claims the benefit of U.S. Provisional Application No. 62/195,593, filed Jul. 22, 2015.

### BACKGROUND INFORMATION

Field of the Disclosure

This invention relates to a USB cable for operation to transmit data at superspeed at a frequency of at least 10 GHz and even at least 15 GHz.

Description of the Related Art

Universal Serial Bus, or “USB”, cable is cable containing multiple insulated conductors for transmitting low voltage differential signals (data) between electronic devices and is used externally from these devices as an interconnection. Shielding of the insulated conductors prevents interference from external signals. This is in contrast to RF cable (antennae wire) which consists of a single insulated conductor for receiving and sending radio frequency electromagnetic waves (external signals) and which is positioned internally within the electronic device. Shielding of the insulated conductor would render the antennae wire inoperable.

USB 2.0 cable is characterized electronically as being capable of transmitting data at a top speed of 0.480 Gbps (gigabits per second) at a maximum frequency of 0.4 GHz. The signal loss (attenuation) of the insulated wires transmitting the data at this frequency is −5.80 dB/m.

USB 3.0 cable is characterized electronically as its shielded differential pair of 32 AWG insulated stranded conductor being capable of transmitting data at a top speed of 5 Gbps per channel at a maximum frequency of 7.5 GHz, which causes an attenuation of −7.1 dB/m for a typical construction utilizing 32 AWG insulated stranded conductor. As compared to the top speed of 0.480 Gbps for the USB 2.0 cable, the top speed of 5 Gbps per channel for the USB 3.0 cable has been defined as SuperSpeed (Gen 1) by the USB Implementers Forum (USB-IF).

The insulation for the data transmitting conductors in the 2.0 and 3.0 USB cables has typically been polyolefin such as polyethylene.

USB 3.1 cable and USB 3.1 type C cable, however, can reach a top speed of 10 Gbps per channel at a frequency of 10 GHz, and this signaling rate is defined as SuperSpeed Plus (SuperSpeed+) or SuperSpeed Gen 2. Notwithstanding the fact that as frequency increases, so does attenuation, the USB 3.1 type C cable is limited in attenuation to −7.2 dB/m (twisted pair structure using 32 AWG stranded conductor) at 10 GHz, which is only a small increase from the attenuation of the USB 3.0 cable. If the USB 3.1 cable were operated at the lower 7.5 GHz frequency of the USB 3.0 cable, the attenuation of the USB 3.1 cable drops to −5.9 dB/m (twisted pair structure using 32 AWG stranded conductor), which reveals a relatively large increase in attenuation when the frequency is increased from the 7.5 GHz to 10 GHz.

The problem of increasing attenuation arising from increasing data signal frequency of cable operation is accentuated when the AWG wire size decreases, i.e. the conductor becomes smaller in diameter. A preferred smaller diameter conductor is 34 AWG. The 32 AWG stranded conductor (7 twisted together strands of wire, each having a diameter of 0.083 mm) has a diameter of 9.8 mils (0.249 mm). The 34 AWG stranded conductor has a diameter of only 7.9 mils (0.201 mm). Accompanying this decrease in conductor diameter, the attenuation of the 34 AWG stranded conductor increases by −1.2 dB/m.

The problem is how to adapt the USB 3.0 cable so that it will perform as a USB 3.1 cable.

### SUMMARY

The present invention solves this problem by providing as one embodiment, a USB cable for transmitting data at superspeed at a frequency of at least 10 GHz, comprising a jacket, and positioned within said jacket at least a power cable and a plurality of shielded insulated conductors for transmitting said data at a speed of 10 Gbps per channel, the insulation of said insulated conductors exhibiting a dissipation factor of no greater than 0.00035 at 10 GHz and comprising melt-fabricable perfluoropolymer. While being capable of transmitting data at speeds up to 10 Gbps per channel, the plurality of insulated conductors are also capable of transmitting data at speeds up to 10 Gbps per channel at 15 GHz. The data transmitted is digital, not radio waves. The insulated conductors transmitting data at speeds up to 10 Gbps per channel are shielded differential pairs (SDP) of the insulated conductors working in tandem with one another to achieve the data transmission.

The USB cable of the present invention, including the USB 3.1 and 3.1 type C cables, exhibits acceptable attenuation by virtue of the shielded differential pairs satisfying the attenuation (differential insertion loss) target at 10 GHz, as follows: by AWG wire size:

| | |
|---|---|
| 28 AWG | −4.9 dB/m |
| 30 AWG | −6.1 dB/m |
| 32 AWG | −7.6 dB/m |
| 34 AWG | −8.8 dB/m |

Source: USB 3.1 type C Cable and Connector Specification, Release 1.1, Apr. 3, 2015, for the stranded wire central conductor of minicoaxial cable. The shielded differential pairs in the USB cable of the present invention exhibits lower attenuations than these targets. The same specification recites the attenuations (differential insertion loss) for the different AWG sizes for stranded wire conductors for insulated twisted pairs and twinax pairs, which is incorporated herein by reference.

Preferably, the dissipation factor of the perfluoropolymer determined on the insulated conductor present in the USB cable of the present invention is no greater than 0.00035, more preferably no greater than the following dissipation factors: 0.00034, 0.00033, 0.00032, 0.00031, 0.00030, 0.00029, 0.00028, 0.00027, 0.00026, or 0.00025, all at 10 GHz. Reference herein to the insulated conductors in the USB cable of the present invention refers to the superspeed data transmitting insulated conductors at 10 GHz unless otherwise indicated. These insulated conductors carry out the data transmission as shielded differential pairs.

It is surprising that the perfluoropolymer insulation described herein enables the insulated conductors to exhibit low attenuations as will be discussed in the DETAILED DESCRIPTION.

Preferably, the copolymer of the insulation of the insulated conductors of the USB cable of the present invention has no greater than 10 per 10⁶ carbon atoms in total amount of thermally unstable end groups, notably the following: —CONH₂, —COF, —COOH, —CH₂OH, and —COOCH₃. The —COOH end group includes both —COOH and —COOH dimer. The thermal instability of these end groups manifests itself as increased volatiles during melt processing and such endgroups are subject to polarization during data (signal) transmission.

In one embodiment of the present invention, the insulated conductors of the USB cable of the present invention are coaxial cables, each of the coaxial cables including shielding, i.e. each of said insulated conductors being shielded. Preferably, the conductor in each of the coaxial cables has a diameter of no greater than 9.8 mils (0.249 mm), and the thickness of the insulation of the insulated conductor insulation is no greater than 8.2 mils (0.21 mm). More preferably, the thickness of the insulation is no greater than 7.3 mils (0.19 mm), and even more preferably no greater than 6.4 mils (0.16 mm).

Another preference is that the conductor in each of the coaxial cables has a diameter of no greater than 7.9 mils (0.201 mm) and the thickness of the insulation of said insulated conductors is no greater than 6.4 mils (0.16 mm). More preferably, the thickness of the insulation is no greater than 5.6 mils (0.14 mm), and even more preferably no greater than 4.9 mils (0.12 mm).

These insulation thicknesses satisfy the impedance specification for the coax insulation of 45 ohms±3 ohms.

The 9.8 mils (0.249 mm) and 7.9 mils (0.201 mm) diameters refer to the 32 and 34 AWG wire sizes, respectively, for stranded conductor (conductor made of wire strands twisted together), which is the preferred conductor for use in the insulated conductors of the minicoaxial cables and twisted pairs and twinaxial pairs in the USB cable of the present invention. The stranded wire conductor is more flexible than if the conductor were a solid wire.

In another embodiment of the present invention, the insulated conductors of the USB cable of the present invention are shielded twisted pairs. Preferably, the conductor of each of the insulated conductors in the twisted pairs of the USB cable of the present invention has a diameter of no greater than 7.9 mils (0.201 mm) and the thickness of the insulation of the insulated conductors is no greater than 5.6 mils (0.14 mm), preferably no greater than 5.1 mils (0.13 mm), more preferably no greater than 4.5 mils (0.12 mm). Another preference is the conductor of the insulated conductors in the twisted pair embodiment has a diameter of no greater than 9.8 mils (0.249 mm) and the thickness of the insulation of said insulated conductors is no greater than 7.0 mils (0.18 mm), preferably no greater than 6.3 mils (0.16 mm), and more preferably no greater than 5.6 mils (0.14 mm). In another variation of the present invention, the insulated conductors of the USB cable of the present invention are shielded twinaxial (twinax) pairs. In one embodiment, the conductor of each of the insulated conductors in the twinax pairs of the USB cable of the present invention has a diameter of no greater than 7.9 mils (0.201 mm) and the thickness of the insulation of the insulated conductors is no greater than 6.4 mils (0.16 mm), preferably no greater than 5.6 mils (0.14 mm), more preferably no greater than 4.9 mils (0.12 mm). In another embodiment, the conductor of the insulated conductors in the twinaxial pair embodiment has a diameter of no greater than 9.8 mils (0.249 mm) and the thickness of the insulation of said insulated conductors is no greater than 8.2 mils (0.21 mm), preferably no greater than 7.3 mils (0.19 mm), and more preferably no greater than 6.4 mils (0.16 mm).

These insulation thicknesses satisfy the impedance specification for the twisted pair and twinax insulation of 90 ohms±5 ohms.

Preferably the melt-fabricable perfluoropolymer of the insulation of the superspeed data transmitting insulated wires is composed of tetrafluoroethylene (TFE)/hexafluoropropylene (HFP) copolymer or tetrafluoroethylene (TFE)/perfluoro(alkyl vinyl ether) (PAVE) copolymer, wherein the alkyl contains 1 to 5 carbon atoms.

Preferably the USB cable of the present invention is the 3.1 USB cable, more preferably the USB 3.1 type C cable, wherein the connectors at the cable ends are reversible with regards to insertion into the receiver of the electronic device. In this cable, the insulated conductors can be in minicoaxial cables or in twisted pair or twinaxial cable, and the insulation of the conductors in these cables can be the TFE/HFP copolymer or the TEF/PAVE copolymer. In this cable, there are at least eight of the insulated conductors present as shielded differential pairs.

The fluorinated perfluoropolymer of the present invention is enabled herein as primary insulation for insulated conductors used in USB 3.1 type cables. However, the fluorinated perfluoropolymer can also result in improved electrical performance when used as the primary insulation for insulated conductors in other similar wire and cable configurations in the communications, electronics, military, aerospace and other similar applications where high frequency signal performance is desired

### BRIEF DESCRIPTION OF THE DRAWING

The FIGURE is a schematic cross-sectional view of one embodiment of a USB superspeed data transmission cable, such as a USB 3.1 cable and a 3.1 type C cable, in enlargement for the purpose of clarity.

### DETAILED DESCRIPTION

With reference to the FIGURE, the USB cable 2 contains a number of elements, characteristic of the USB 3.1 cable and 3.1 type C cable. One of these elements is the minicoaxial cable 4 of which there are four such cables shown in cross-section in the USB cable 2. Each minicoaxial cable 4 consists of a central conductor 6 composed of strands of wire twisted together, polymer insulation 8 in cross-section surrounding the conductor 6, metal braid shielding 10, to prevent interference from external signals, in cross-section over the outer surface of the polymer insulation 8, and polymer jacket 12 in cross-section surrounding the metal braid 10. The microcoaxial cables 4 are the superspeed data transmitting cables of the USB cable 2. The polymer insulation 8 of these coaxial cables 4 comprises the melt-fabricable perfluoropolymer having the dissipation factor of no greater than 0.00035 and preferably no greater than any of the following: 0.00034, 0.00033, 0.00032, 0.00031, 0.00030, 0.00029, 0.00028, 0.00027, 0.00026, and 0.00025, all at 10 GHz as described herein. The superspeed minicoaxial cables 4 can be replaced by twisted pairs of insulated conductors or twinax pairs of insulated conductors, each containing a central conductor of strands of wire twisted together surrounded by polymer insulation. The twisted pairs and twinax pairs are shielded by (wrapped with) metal foil/polymer film laminate to which prevents interference from external signals, such as crosstalk, between pairs. The replacement twisted pairs and twinax pairs would then be the superspeed data transmitting cables of the USB cable. The polymer insulation would be the same perfluoropolymer as the polymer insulation 8 described above. The superspeed data transmitting cables, whether they are minicoax, twisted pair or twinax, of the USB cable 2 can be present in greater number in the USB cable 2 than shown in the FIGURE. These superspeed cables provide the cable 2 with superspeed data transmission.

Four minicoaxial cables 4 or two twisted or twinax pairs within cable 2 form one channel capable of transmitting data at 10 Gbps at 10 GHz. This is characteristic of the USB 3.1 cable. Eight minicoaxial cables 4 or four twisted or twinax pairs within cable 2 double the bandwidth to 20 Gbps at 10 GHz. This is characteristic of USB 3.1 type cable. Each pair of the minicoaxial cables 4 in the group of four cables 4 depicted in the FIGURE are a shielded differential pair, wherein the shielding 10 is part of each minicoaxial cable. Each twisted pair and each twinax cable are a shielded differential pair, wherein the shielding is provided as described above.

The AWG size of the conductor 6 is preferably no greater than AWG 26, and includes smaller AWG wire sizes of 28, 30, 32, 34, and 36. The thickness of the insulation, such as insulation 8, is that which is effective to provide the electrical insulation (impedance) required for transmission of the superspeed data, i.e. to meet the design target of characteristic impedance and to minimize impedance discontinuity for data transmission in the whole USB system.

When the conductor is in a twisted or twinaxial pair of insulated conductors (cable), the insulation thickness can be less than when the insulated conductor is a mini-coaxial cable for the same AWG wire size. As the AWG wire size decreases so does the insulation thickness to achieve the electrical effect described above.

The insulation thickness for 32 AWG minicoaxial cable and minicoaxial cable wherein the conductor is smaller in size preferably meets (satisfies) the impedance design target of 45 ohms±3 ohms, especially for the USB 3.1 type C cable. The insulation thickness for 32 AWG twisted pairs and twinax pairs and such pairs wherein the conductor is smaller in size preferably meets (satisfies) the impedance design target of 90 ohms±5 ohms, especially for the USB 3.1 type C cable.

Another element within the USB cable 3.1 is the power line 14 (supply) and power line 16 (return), both shown in cross-section, and both comprising a central conductor 18 of twisted together strands of wire and polymer insulation 20 surrounding the central conductor 18. An example of the polymer of the polymer insulation 20 is polyvinyl chloride. The power lines 14 and 16 of the cable 2 preferably have a maximum power output of 100 watts (20V at 5 A).

Another element within the USB cable 2 is the shielded twisted pair 22 of polymer-insulated conductors, each polymer-insulated conductor comprising a central conductor 24 of twisted together strands of wire surrounded by polymer insulation 26, all shown in cross-section. This twisted pair 22 is the USB 2.0 component of the USB cable 2, USB cable 2.0 having a top data speed of 0.48 Gbps. This is the slow speed data transmission cable of cable 2, providing connectivity to interfaces compatible with this operating condition. An example of polymer of the polymer insulation 26 is polyethylene.

Examples of other elements not shown, but which can be present within the cable 2 include a sideband use cable (SBU) for additional signals such as analog radio signals, and filler to occupy empty spacing between elements within cable 2.

Metal braid 28, shown in cross section, surrounds the assemblage of coaxial cables 4, power lines 14 and 16, and twisted pair 22, and jacket 30 surrounds the metal braid 28. The metal braid 28 provides shielding for the entire cable 2 and can also serve as the ground for the cable. This shielding can have other forms, such as the composite of an inner metal braid and an outer metal shield having an aluminum metallized polyester film sandwiched between them. An example polymer of the jacket 30 is ethylene/vinyl acetate copolymer.

The elements within the cable 2 are shown as though they were loosely positioned. Preferably the elements within the cable are tightly bound together, such as by polyester tape wrapping (not shown) of the elements together prior to application of braid 28.

The perfluoropolymers used in the USB cable of the present invention are those that are melt flowable so that they are melt-fabricable, i.e., they can be extruded in the molten state to form the insulation on the conductor of the superspeed data transmitting insulated conductors, such as insulation 8 of the FIGURE. The melt flow rate (MFR) of these perfluoropolymers is preferably at least about 20 g/10 min, more preferably at least about 25 g/10 min, still more preferably at least about 28 g/10 min, even more preferably at least about 30 g/10 min. High MFR is preferred to provide the flowability of the molten perfluoropolymer desired for obtaining intimate contact without air gaping at the insulation/conductor interface during the extrusion process forming the insulation. Air gaping contributes to an increase in dissipation factor. MFR is measured according to ASTM D-1238 at 372° C., using a 5.0 kg weight on the molten perfluoropolymer. As indicated by the prefix “per”, the monovalent atoms bonded to the carbon atoms making up the perfluoropolymer chain are all fluorine atoms. Other atoms may be present in the polymer end groups, i.e. the groups that terminate the polymer chain.

Examples of perfluoropolymers that can be used in the present USB cable include the copolymers of tetrafluoroethylene (TFE) with one or more perfluorinated polymerizable comonomers, such as perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, respectively known as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The TFE/PAVE copolymer can be made using several PAVE monomers, such as the TFE/perfluoro(methyl vinyl ether)/perfluoro(propyl vinyl ether) terpolymer, sometimes called MFA by the manufacturer. The TFE/PAVE copolymers are most commonly referred to as PFA (perfluoroalkoxy perfluoropolymer). PFA typically contains at least about 1 wt % PAVE, including when the PAVE is PPVE or PEVE, and will typically contain about 1-15 wt % PAVE. When PAVE includes PMVE, the composition is about 0.5-13 wt % PMVE and about 0.5 to 3 wt % PPVE, the remainder to total 100 wt % being TFE. The MFR determination conditions for this perfluoropolymer is disclosed in ASTM D 3307-93. The maximum MFR, applicable to each minimum MFR recited above as ranges of MFR in one embodiment is 50 g/10 min, in another embodiment is 46 g/10 min, in another embodiment is 40 g/10 min, and in another embodiment is 36 g/10 min.

Another group of perfluoropolymers is the TFE/HFP copolymers, which are commonly referred to as FEP (fluorinated ethylene propylene). In these copolymers, the HFP content is typically about 9-17 wt % (calculated from HFPI×3.2). Preferably, the TFE/HFP copolymer includes a small amount of additional comonomer to improve properties. The preferred TFE/HFP copolymer is TFE/HFP/PAVE terpolymer wherein the PAVE is PEVE or PPVE, and wherein the HFP content is about 9-17 wt % and the PAVE content, preferably PEVE, is about 0.2 to 3 wt %, the remainder being TFE to total 100 wt % of the copolymer. The MFR determination conditions for this perfluoropolymer are disclosed in ASTM D 2116-91a. The maximum MFR, applicable to each minimum recited above as ranges of MFR is 40 g/10 min, preferably 36 g/10 min.

It is preferred that the perfluoropolymer be partially crystalline, that is, not an elastomer. By partially crystalline is meant that the polymers have some crystallinity and are characterized by a detectable melting point measured according to ASTM D 3418, and a melting endotherm of at least about 3 J/g. The dissipation factors mentioned above for the perfluoropolymer applies to each for each TFE/HFP copolymers and TFE/PFA copolymer mentioned above, both collectively and individually.

The perfluoropolymers can be manufactured by polymerization of the appropriate monomers in a variety of media by known methods. In one embodiment the perfluoropolymer is made, i.e. polymerized, in an aqueous medium for economy and the ability of this polymerization to provide perfluoropolymer with desirable properties, such as melt flowability along with the strength required for the insulation to retain its integrity during handling. Polymerization in an aqueous medium necessarily results in the medium containing one or more additives dissolved in the medium to form ionic species present in the medium. An example of such additive is the polymerization initiator such as ammonium persulfate, chain transfer agent such as methanol, and/or buffer such as ammonium ω-hydroxyfluorocarbonate. Dispersing agent for the perfluoropolymer particles formed during the polymerization can also be present as an additive to the aqueous medium. While recovery of the perfluoropolymer from the aqueous medium involves steps to remove these additives, enough of one or more of the additive can remain associated with the perfluoropolymer in minute amounts, which are nevertheless sufficient to cause an increase in dissipation factor of the perfluoropolymer. This preference also applies to the TFE/HFP copolymer and TFE/PAVE copolymer mentioned above.

It is further preferred that the melt-fabricable perfluoropolymer, including the FEP and PFA copolymers mentioned above, be polymerized so that the polymerized particles of the perfluoropolymer have a uniform melt flow rate, not an MFR that changes stepwise during the polymerization, e.g. from a low MFR core and high MFR shell.

Another contributor to dissipation factor of the perfluoropolymer is the thermally unstable end groups of the polymer chain, notably —CONH₂, —COF, —COOH, —CH₂OH, and —COOCH₃, which result from the polymerization process. Differences in the polymerization processes, such as in the use of an additive mentioned above, can result in only some of these thermally unstable end groups being present in the perfluoropolymer. The perfluoropolymer as polymerized in an aqueous medium will have at least hundreds of such thermally unstable end groups and possibly —CF₂H end groups as well, depending on the particulars of the polymerization process. Various end group stabilization methods can be used to reduce these unstable end groups and/or not form the —CF₂H end group, with fluorination discussed below being preferred since it can convert most if not all end groups to the thermally stable —CF₃ end group.

Another embodiment of the present invention can also be described as USB cable for transmitting data at superspeed at a frequency of at least 10 GHz, comprising a jacket, and positioned within said jacket at least a power cable and at least one shielded differential pair for transmitting said data at a speed of 10 Gbps, each member of said pair comprising an insulated conductor, the insulation of said insulated conductors exhibiting a dissipation factor of no greater than 0.00035 at 10 GHz and comprising melt-fabricable perfluoropolymer. The cable preferably comprises at least two of said shielded differential pairs and more preferably at least four of said shielded differential pairs.

The perfluoropolymer forming the insulation of the superspeed data transmitting is subjected to strenuous conditions of fluorination prior to extrusion to form the conductor insulation. This reduces the dissipation factor by an effective amount to enable the superspeed data transmission insulated conductors to contribute positively to the attenuations arising other than from the insulation itself, so as to satisfy the attenuation target for the particular AWG wire size in the insulated conductor and be useful in the USB 3.1 cable of the present invention. The fluorination obtains the low values of dissipation factor described above. The effect of the fluorination is at least to convert the thermally unstable end groups identified above to the stable —CF₃ end group. The same is true for the αCF₂H end group if present.

According to one embodiment of fluorination, the fluorination is carried out by exposing pellets of the perfluoropolymer to fluorine gas such as disclosed in U.S. Pat. No. 4,753,658, wherein the pellets are placed in a double cone blender, heated to a temperature of 200° C., followed by addition of a fluorine/nitrogen mixture and rotating the blender while continuing the heating for a period of time sufficient to result in conversion of most if not all of the aforementioned thermally unstable end groups to the —CF₃ end group. In one embodiment, such heating period is for from 6 to 8 hr. Typically, the size of the pellets can be 2 to 3 mm in diameter. These temperature and heating times are preferred minimums for the fluorination. In this embodiment, the pellets remain in solid form during the fluorination treatment.

According to another embodiment, the fluorination is carried out on the perfluoropolymer being in molten phase in a twin-screw extruder as disclosed in U.S. Pat. No. 6,838,545. The extruder is equipped with special screws that after melting the polymer, forces the melt into a zone within the extruder barrel that is equipped with multiple mixing elements. A mixture of fluorine and nitrogen is fed into this zone for reaction with the molten polymer, especially converting the aforementioned unstable end groups and the —CF₂H end group, if present, to the stable end group αCF₃. The resultant fluorinated perfluoropolymer is extruded into pellets. Preferably the fluorination of the melt fabricable fluoropolymer, whether it be the TFE/HFP copolymer or the TFE/PAVE copolymer, reduces the number of thermally unstable end groups —CONH₂, —COF, —COOH, —CH₂OH, and —COOCH₃, to in-total be no greater than 10 per 10⁶ carbon atoms, preferably no greater than 8 per 10⁶ carbon atoms.

The disclosures of U.S. Pat. Nos. 4,753,658 and 6,838,545 are incorporated herein by reference. After fluorination, the pellets are subjected to sparging, such as by flowing nitrogen gas through the pellets to remove extractable fluoride and unreacted fluorine.

The resultant fluorinated perfluoropolymer is extruded by conventional process onto the stranded wire conductor to form the insulation surrounding the conductor, thereby obtaining the superspeed insulated conductor, by virtue of the perfluoropolymer having a low dissipation factor mentioned above, for use in the USB superspeed cable of the present invention. The extrusion can be carried out such that the insulation is solid perfluoropolymer, i.e. unfoamed, or the insulation is foamed by conventional extrusion processes. Preferably the extrusion foaming is carried out by blending foam cell nucleating agent with the fluoropolymer prior to extrusion, and during extrusion, injecting nitrogen into the molten fluoropolymer. Preferably the extrusion is melt draw down wherein the foaming caused by expansion of the injected nitrogen takes place when the extruded perfluoropolymer is coated onto the conductor, the presence of the foam cell nucleating agent causing the foaming to be in the form of fine uniform voids within the thickness of the insulation. Preferably, the void content of the foamed insulation is 30 to 50% as determined in accordance with the calculation disclosed in U.S. Pat. No. 8,178,592.

Assemblage of the plurality of these insulated conductors, whether the insulation is solid or foamed, to form shielded differential pairs, the power lines and other elements of the USB cable as desired, and braiding and jacketing of this assemblage are carried out by conventional processes.

It is surprising that the replacement of almost all of the thermally unstable end groups by fluorination of the perfluoropolymer enables the superspeed data transmitting cables used in the USB 3.1 and 3.1 type C cables in accordance with the present invention to exhibit low attenuations than the maximums specified for these cables. U.S. Pat. No. 7,638,709 (U.S. '709) discloses that such replacement has the disadvantage of high return loss due to lack of affinity of the TFE/HFP copolymer insulation for the conductor. While the highly fluorinated TFE/HFP copolymer can have low dissipation factor, the resulting conductor insulated with this copolymer will have poor electrical performance because of the relationship of the insulation with the conductor. In this regard, any electrical benefit arising from low dissipation factor is canceled out by the poor interaction at the interface between the insulation and the conductor.

U.S. '709 discloses the extrusion process for applying the TFE/HFP copolymer insulation to the conductor to be the melt-draw down type. This extrusion involves extruding the copolymer as a tube surrounding the conductor, and drawing a vacuum within the extruded tube to draw the tube down onto the conductor. This is the preferred method for forming the insulation around the conductor to form the superspeed data transmitting cables used in the cables of the present invention.

The tubular extrudate, becoming conical in shape by the melt draw down is still molten upon contact with the conductor. While U.S. '709 is directed to forming a foamed insulation, the foaming does not start until the molten polymer is in contact with the conductor. This delay in foaming enables the molten polymer to retain its integrity during the drawing that occurring during melt draw down. The melt is solid and not foamed at the time of this contact.

U.S. '709 discloses that the TFE/HFP copolymer needs some thermally unstable end groups in order to have greater affinity for the conductor, and this greater affinity reduces return loss of the resultant coaxial cable. This greater affinity manifests itself by greater adhesion of the insulation to the conductor, which is measured as an increase in strip force. According to U.S. '709, the amount of unstable end groups that should be retained by the TFE/HFP copolymer, e.g. by a lesser degree of fluorination, is from 30 to 120 per 10⁶ carbon atoms. The present invention has discovered that for the small diameter conductors made of twisted together wires used in the present invention, notwithstanding the complexity of the conductor surface presented to the melt drawn down insulation of perfluoropolymer, the interface between conductor and insulation does not present the return loss problem disclosed in U.S. '709.

### EXAMPLES

The dissipation factor is determined on 2.5 mm thick compression molded plaques of the perfluoropolymer in accordance with ASTM 2520, Method B (Resonant Cavity Perturbation Technique), wherein the electric field inside the resonant cavity is parallel to the length (15.25 cm) of the plaque.

Unstable end groups of the perfluoropolymer with respect to the present invention is determined by the following procedure: A 0.25-0.3 mm thick test film of the perfluoropolymer is prepared by compression molding and then subjected to FT-IR analysis to analyze for the amount of thermally unstable end groups by absorption at a wavelength characteristic of the end group as follows:

| | IR wavelength | Calibration factor |
|---|---|---|
| End group | (cm−1) | (extinction coefficient) |
| —CONH₂ | 3440 | 914 |
| —COF | 1884 | 381 |
| —COOH | 1813 | 455 |
| —COOH dimer | 1775 | 432 |
| —CH₂OH | 3648 | 2325 |
| —COOCH₃ | 1795 | 355 |
| —CF₂H | 3005 | 22047 |

The value of the extinction coefficient depends on the absorption at the diagnostic wavelength.

Similarly, a film of a reference material known to have none of the end groups to be analyzed is produced by exposing pellets of the perfluoropolymer to fluorine such as disclosed in U.S. Pat. No. 4,753,658, wherein the pellets are placed in a double cone blender, heated to a temperature of 200° C., followed by continuous addition of a 25 mole % fluorine and 75 mole % nitrogen mixture and rotating the blender while continuing the heating for 8 hr. The fluorination procedure is repeated on the pellets until films that are molded and scanned from the resulting cubes indicate no change in absorption of the known end group peaks from one fluorination treatment to the subsequent treatment. Fluorination at lower temperatures or lower fluorine concentration can leave some unstable end groups, whereby the reference film would not be fully fluorinated and therefore not be useful detecting all unstable ends.

The differential absorption at each wavelength corresponding to an end group is determined and this is converted to number of end groups per 10⁶ carbon atoms by the equation: end groups/10⁶ (ppm)=(differential absorbance×extinction coefficient)/test film thickness in mm.

The end group —CF₂H is not a thermally unstable end group with respect to TFE/HFP copolymer at the melt processing (extrusion) temperature of about 390° C. In any event, the number of —CF₂H end groups is determined the same way as above, the characteristic absorption peak being at 3005 cm⁻¹.

### Polymerization Example 1

A TFE/HFP/PEVE polymerization is conducted using the conditions of U.S. Patent Application Publication 2012/0004365A1 Example 7 except the initiator pump rate during reaction is increased from 3.5 ml/min to 3.67 ml/min. The resulting polymer has an HFP content of 10.2%, a PEVE content of 1.2% and a MFR of 28.8 g/10 min. This perfluoropolymer is isolated from the dispersion by high-shear mechanical coagulation and dried.

### Fluorination Example 1

The dried perfluoropolymer from Polymerization Example 1 is fluorinated using the procedures disclosed in U.S. Pat. No. 6,838,545 Example 2, except that the section containing the injection, mixing and reaction sections is increased from 11 L/D to 26 L/D with the reaction zone now containing 20 TME elements and 1 ZME element and the ratio of fluorine to polymer adjusted to 2,000 ppm by weight. End group analysis reveals that only 8 thermally unstable end groups per 10⁶ carbon atoms are present in the copolymer and no —CF₂H end groups are present. The dissipation factor of the copolymer is 0.00023 at 10 GHz.

### Fluorination Example 2

The dried perfluoropolymer from Polymerization Example 1 is fluorinated using the procedures described in Fluorination Example 1 except the ratio of fluorine to polymer is adjusted to 900 ppm by weight. The perfluoropolymer is then fluorinated again by exposing pellets of the previously fluorinated perfluoropolymer to fluorine such as disclosed in U.S. Pat. No. 4,753,658, wherein the pellets are placed in a double cone blender, heated to a temperature of 200° C., followed by addition of a 25 mole % fluorine and 75 mole % nitrogen mixture and rotating the blender while continuing the heating for 8 hr. The double cone blender fluorination procedure is repeated. The resultant perfluoropolymer exhibits a dissipation factor of 0.00031 at 10 GHz and contains less than 2 unstable end groups per 10⁶ carbon atoms, and no —CF₂H end groups.

### Fluorination Example 3

A TFE/PPVE copolymer having an MFR of 42 g/10 min and a PPVE content of 5.2 weight percent is fluorinated by exposing pellets to fluorine such as disclosed in U.S. Pat. No. 4,753,658, wherein the pellets are placed in a double cone blender, heated to a temperature of 200° C., followed by addition of a 10 mole % fluorine and 90 mole % nitrogen mixture and rotating the blender while continuing the heating for 7 hr. The resultant perfluoropolymer exhibits a dissipation factor of 0.00034 at 10 GHz and contains 5 unstable end groups per 10⁶ carbon atoms and no —CF₂H end groups.

### Extrusion Example 1

The perfluoropolymer prepared under Polymerization example 1, prepared and fluorinated under Fluorination Example 1, is extruded by melt-draw down extrusion onto a 32 AWG stranded wire conductor (7/0.083 mm) to produce an insulation thickness of 0.19 mm, OD 0.62 mm, under the following conditions:

Die 6.5 mm, tip 2.4 mm, DRB=1.05, DDR=112

30 mm extruder, L/D=24-28

Line speed 200 m/min

Temperature profile in the extruder, (Unit: ° C.)

| | Zone | | | | | | | |
|---|---|---|---|---|---|---|---|---|
| | Zone 1 | Zone 2 | Zone 3 | Zone 4 | Zone 5 | Clamp | Head | Die |
| Temp. set | 330 | 340 | 350~365 | 360~375 | 370~380 | 370~380 | 375~386 | 375~386 |

The resultant insulated conductor is shielded with metal braid and then jacketed, followed by cutting into eight lengths. The resultant minicoaxial cables are then incorporated into USB 3.1 type C cable as four shielded differential pairs.

The shielded differential pairs of minicoaxial cable each exhibit an attenuation less than −7.6 dB/m at 10 GHz.

### Extrusion Example 2

The perfluoropolymer prepared under Polymerization Example 1 and after fluorination in accordance with Fluorination 2 is blended with 0.3 wt % of foam cell nucleating agent comprising 91.1 w % boron nitride, 2.5 wt % calcium tetraborate, and 6.4 wt % of the barium salt of telomer B sulfonic acid as described in U.S. Pat. No. 8,178,592. Extrusion onto 32 AWG stranded conductor to form an insulation that is 7.2 mils thick (0.18 mm) and having a void content of 45% provides the desired impedance of 48 ohms for the insulation. Eight lengths of this foamed insulated conductor, shielded and jacketed, are incorporated into a USB 3.1 type C cable. The attenuation of each shielded differential pair on these minicoaxial cables is less than −6.8 dB/m at 10 GHz for the superspeed cable.

The extrusion conditions are as follows:
20 mm screw, L/D=28-32
Die 1.6 mm, Tip 0.8 mm
Conductor OD: 0.24 mm,
Insulation OD 0.6 mm
Nitrogen injection pressure 350-400 Bar, for a nitrogen injector with flow rate of 8 cc/min tested at 300 Bar
Line speed 80 m/min
   Temperature profile: (unit ° C.)

| | Zone | | | | | | | |
|---|---|---|---|---|---|---|---|---|
| | Zone 1 | Zone 2 | Zone 3 | Zone 4 | Zone 5 | Clamp | Head | Die |
| Temp. set | 290~300 | 340~360 | 370~380 | 375~385 | 365~375 | 365~375 | 350~360 | 340~360 |

### Extrusion Example 3

The perfluoropolymer prepared under Fluorination Example 3 is extruded onto 32 AWG stranded wire conductor in a manner similar to Extrusion Example 1 to obtain the same insulation thickness. Lengths of this insulated conductor, after braiding and jacketing, are incorporated into a USB 3.1 type C cable. The shielded differential pairs of the resultant minicoaxial cables exhibit an attenuation that is less than −7.6 dB/m at 10 GHz.

All of the superspeed cables prepared in the Examples are capable of transmitting data at 10 Gbps per channel at 10 GHz.

What is claimed is:

1. A USB cable for transmitting data at superspeed at a frequency of at least 10 GHz, comprising a jacket, and positioned within said jacket at least a power cable and a plurality of shielded insulated conductors for transmitting said data at speeds up to 10 Gbps per channel, the insulation of said insulated conductors exhibiting a dissipation factor of no greater than 0.00035 at 10 GHz and comprising melt-fabricable perfluoropolymer.

2. The cable of claim 1 wherein said dissipation factor is no greater than 0.00031.

3. The USB cable of claim 1 wherein said insulated conductors are coaxial cables, each of said insulated conductors being shielded.

4. The USB cable of claim 3 wherein the conductor in each said coaxial cables has a diameter of no greater than 9.8 mils (0.249 mm) and the thickness of the insulation of said insulated conductor insulation is no greater than 8.2 mils (0.21 mm).

5. The USB cable of claim 4 wherein said thickness of said insulation is no greater than 6.4 mils (0.16 mm).

6. The USB cable of claim 3 wherein the conductor in each said coaxial cables has a diameter of no greater than 7.9 mils (0.201 mm) and the thickness of the insulation of said insulated conductors is no greater than 6.4 mils (0.16 mm).

7. The USB cable of claim 6 wherein said thickness of said insulation is no greater than 4.9 mils (0.12 mm).

8. The USB cable of claim 1 wherein said insulated conductors are either twisted pair or twinaxial pair, each of said pair being shielded.

9. The USB cable of claim 8 wherein the conductor of said insulated conductors in said twisted pair has a diameter of no greater than 7.9 mils (0.201 mm) and the thickness of the insulation of said insulated conductors is no greater than 5.6 mils (0.14 mm).

10. The USB cable of claim 8 wherein the conductor of said insulated conductors in said twisted pair has a diameter of no greater than 9.8 mils (0.249 mm) and the thickness of the insulation of said insulated conductors is no greater than 7.5 mils (0.19 mm).

11. The USB cable of claim 8 wherein the conductor of said insulated conductors in said twinaxial pair has a diameter of no greater than 7.9 mils (0.201 mm) and the thickness of the insulation of said insulated conductors is no greater than 6.4 mils (0.16 mm).

12. The USB cable of claim 8 wherein the conductor of said insulated conductors in said twinaxial pair has a diameter of no greater than 9.8 mils (0.249 mm) and the thickness of the insulation of said insulated conductors is no greater than 8.2 mils (0.21 mm).

13. The USB cable of claim 1 wherein the total amount of —CONH₂, —COF, —COOH, —CH₂OH, and —COOCH₃ thermally unstable end groups of said perfluoropolymer are no greater than 10 per 10⁶ carbon atoms.

14. The USB cable of claim 1 wherein said perfluoropolymer is fluorinated to convert the thermally unstable end groups selected from —CONH₂, —COF, —COOH, —CH₂OH, and —COOCH₃ of said perfluoropolymer to —CF₃ end groups, and wherein the total amount of said thermally unstable end groups of the resultant fluorinated perfluoropolymer is no greater than 10 per 10⁶ carbon atoms.

15. The USB cable of claim 1 containing at least eight of said insulated conductors as shielded differential pairs.

16. The USB cable of claim 1 wherein said insulation is foamed.

17. The USB cable of claim 1 wherein said melt-fabricable perfluoropolymer is tetrafluoroethylene/hexafluoropropylene copolymer or tetrafluoroethylene/perfluoro(alkyl vinyl ether) copolymer, wherein the alkyl contains 1 to 5 carbon atoms.

18. The USB cable of claim 1 wherein the melt flow rate for said melt-fabricable perfluoropolymer is at least 28 g/10 min.
